(19) United States
(12) Patent Application Publication
(10) Pub. No.: US 2017/0116588 A1
(43) Pub. Date: Apr. 27, 2017

(54) SYSTEMS AND METHODS FOR PROVIDING CUSTOMIZED TOKENS

(71) Applicant: INSTANT ACCESS 360 INC., TORONTO (CA)

(72) Inventors: GEOFFREY DOUGLAS CONANT, WATERDOWN (CA); ROY ALEXANDER ROEDGER, TORONTO (CA)

(21) Appl. No.: 15/331,663

(22) Filed: Oct. 21, 2016

Related U.S. Application Data
(60) Provisional application No. 62/245,550, filed on Oct. 23, 2015.

(51) Int. Cl. G06Q 20/18; G06Q 20/38; H04L 29/06; G06Q 20/34; G06Q 20/40

(52) U.S. Cl. CPC G06Q 20/18; G06Q 20/34; G06Q 20/4016; G06Q 20/4014; H04L 63/1483; G06Q 20/3829

(57) ABSTRACT

Systems, methods, apparatuses, and computer readable media are provided for providing a token such as a financial services card, that is issued by a physical token issuance authority, the token having customized machine readable data stored thereon and the system adapted for use by a kiosk operator. An exemplary system may include a kiosk, a secure networking connection and a backend platform, the kiosk for provisioning and/or customizing the token in unsecured and/or low security locations.

### FIELD

The present disclosure generally relates to the field of data security and customized token provisioning.

### INTRODUCTION

The issuance and provisioning of payment cards and other forms of tokens may be a challenge, given security requirements and the potential for fraud and breaches of privacy.

### SUMMARY

In a first aspect, a system is provided, the system configured for providing a physical token, issued by a physical token issuance authority, the physical token having customized machine readable data stored thereon and the system adapted for use by a kiosk operator, the system comprising: a kiosk, the kiosk comprising: a first computing device having a first processor, first computer readable memories and first data storage, the first computing device configured to provide: (i) a user interface for use by the kiosk operator to initiate provisioning of the physical token for a token requester, the user interface configured to receive electronic indicia of credentials provided by the token requester; and (ii) a validation unit configured to transmit the electronic indicia of credentials to a backend platform and to receive, in response to the transmission of the electronic indicia of credentials, electronic indicia of a provisioning determination; a physical token customization unit configured to (i) receive a token blank and to (ii), upon the computing device receiving a positive electronic indicia of the provisioning determination, customize the token blank by ascribing customized machine readable data based at least on the electronic indicia of credentials provided by the token requester on the token blank; and a network connection unit configured for establishing one or more communication links between the first computing device and the backend platform; a secure networking connection including at least the one or more communication links between the computing device and the backend unit, the secure networking connection adapted to communicate validation and credential information; the backend platform, the backend platform comprising: a second computing device having a second processor, second computer readable memories and second data storage, the second computing device configured to provide: (i) a receiver unit configured to receive, through the secure networking connection, the electronic indicia of credentials from the kiosk; (ii) a rules engine, configured to maintain, on the second data storage, one or more electronic rules based at least on requirements provided by the token issuance authority; and (iii) a verification unit, configured to determine, by applying the one or more electronic rules, whether a token requester is approved for the requested physical token.

In another aspect, the kiosk further includes: a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, bypassing the first computing device; and wherein the physical token customization unit of the kiosk is further configured to customize the token blank using at least the received personal identification information.

In another aspect, the kiosk further includes: a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, bypassing the first computing device; and wherein the verification unit of the backend platform is further configured to receive personal identification information through the second set of communication links, and the determination by the verification unit is based at least on the received personal identification information.

In another aspect, the kiosk may further comprise: an anti-tampering unit configured to detect tampering attempts, including at least one of a tilt sensor, a vibration sensor, a proximity sensor, a location sensor, a temperature sensor, a gyroscope, an accelerometer, a case open sensor, and a power loss sensor.

In another aspect, the system further comprises: an anti-spoofing unit configured to detect spoofing attempts, including at least one of a packet analyzer, a firewall, and a source authentication unit.

In another aspect, a kiosk is provided, the kiosk comprising: a first computing device having a first processor, first computer readable memories and first data storage, the first computing device configured to provide: (i) a user interface for use by the kiosk operator to initiate provisioning of the physical token for a token requester, the user interface configured to receive electronic indicia of credentials provided by the token requester; and (ii) a validation unit configured to transmit the electronic indicia of credentials to a backend platform and to receive, in response to the transmission of the electronic indicia of credentials, electronic indicia of a provisioning determination; a physical token customization unit configured to (i) receive a token blank and to (ii), upon the computing device receiving a positive electronic indicia of the provisioning determination, customize the token blank by ascribing customized machine readable data based at least on the electronic indicia of credentials provided by the token requester on the token blank; and a network connection unit configured for establishing one or more communication links between the first computing device and the backend platform.

In another aspect, a system is provided, configured to provide a customized virtual token issued by a token issuance authority, the virtual token having customized machine readable data stored thereon and the system adapted for use by a kiosk operator, the system comprising: a kiosk, the kiosk comprising: a first computing device having a first processor, first computer readable memories and first data storage, the first computing device configured to provide: (i) a user interface for use by the kiosk operator to initiate provisioning of the virtual token for a token requester, the user interface configured to receive electronic indicia of credentials provided by the token requester; and (ii) a validation unit configured to transmit the electronic indicia of credentials to a backend platform and to receive, in response to the transmission of the electronic indicia of credentials, electronic indicia of a provisioning determination; a virtual token customization unit configured to, upon the computing device receiving a positive electronic indicia of the provisioning determination, customize a virtual token blank by ascribing customized machine readable data based at least on the electronic indicia of credentials provided by the token requester on the virtual token blank; and a network connection unit configured for establishing one or more communication links between the first computing device and the backend platform; a secure networking connection including at least the one or more communication links between the computing device and the backend unit, the secure networking connection adapted to communicate validation and credential information; the backend platform, the backend platform comprising: a second computing device having a second processor, second computer readable memories and second data storage, the second computing device configured to provide: (i) a receiver unit configured to receive, through the secure networking connection, the electronic indicia of credentials from the kiosk; (ii) a rules engine, configured to maintain, on the second data storage, one or more electronic rules based at least on requirements provided by the token issuance authority; and (iii) a verification unit, configured to determine, by applying the one or more electronic rules, whether a token requester is approved for the requested virtual token.

In another aspect, an automated kiosk system is provided, configured to provide a token in a non-secure environment, the token issued by a token issuance authority having customized machine readable data stored thereon, and being provided contemporaneously upon receiving a token provisioning request, the automated kiosk system comprising: a first computing device having a first processor, first computer readable memory and a first data storage, the first computing device configured to provide: (i) a user interface to, responsive to the token provisioning request, initiate request signals for the token for a token requester, the user interface configured to receive electronic indicia of credentials provided by the token requester; and (ii) a validation unit configured to transmit the electronic indicia of credentials to a backend platform and to receive, in response to the transmission of the electronic indicia of credentials, electronic indicia of a provisioning determination; a token customization unit configured to (i) receive a token blank and to (ii), upon the first computing device receiving a positive electronic indicia of the provisioning determination, customize the token blank by ascribing customized machine readable data based at least on the electronic indicia of credentials provided by the token requester on the token blank; and a network connection unit configured for establishing one or more communication links between the first computing device and a backend platform; a secure networking connection including at least the one or more communication links between the first computing device and the backend platform, the secure networking connection adapted to communicate validation and credential information; the backend platform comprising: a second computing device having a second processor, second computer readable memories and second data storage, the second computing device configured to provide: (i) a receiver unit configured to receive, through the secure networking connection, the electronic indicia of credentials from the first computing device; (ii) a token issuance determination engine, configured to maintain, on the second data storage, one or more electronic conditions based at least on requirements provided by the token issuance authority; and (iii) a verification unit, configured to determine, by applying the one or more electronic conditions, whether a token requester is approved for the requested token.

In some embodiments, the automated kiosk system further includes a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, the second set of communication links bypassing the first computing device; and wherein the token customization unit of the first computing device is further configured to customize the token blank using at least the received personal identification information.

In some embodiments, the automated kiosk system further includes: a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, bypassing the first computing device; and wherein the verification unit of the backend platform is further configured to receive personal identification information through the second set of communication links, and the determination by the verification unit is based at least on the received personal identification information.

In some embodiments, the automated kiosk system further comprises an anti-tampering unit configured to detect tampering attempts, including at least one of a tilt sensor, a vibration sensor, a proximity sensor, a location sensor, a temperature sensor, a gyroscope, an accelerometer, a case open sensor, and a power loss sensor, the anti-tampering unit configured for communication with at least one of the first computing device and the second computing device to transmit signals representative of a probability of tampering.

In some embodiments, the automated kiosk system further comprises: an anti-spoofing unit configured to detect spoofing attempts, including at least one of a packet analyzer, a firewall, and a source authentication unit, the anti-spoofing unit configured for communication with at least one of the first computing device and the second computing device to transmit signals representative of a probability of tampering.

In some embodiments, the automated kiosk system further comprises: an anti-tampering unit configured to detect tampering attempts, including at least one of a tilt sensor, a vibration sensor, a proximity sensor, a location sensor, a temperature sensor, a gyroscope, an accelerometer, a case open sensor, and a power loss sensor, the anti-tampering unit configured for communication with at least one of the first computing device and the second computing device to transmit signals representative of a probability of tampering; and an anti-spoofing unit configured to detect spoofing attempts, including at least one of a packet analyzer, a firewall, and a source authentication unit, the anti-spoofing unit configured for communication with at least one of the first computing device and the second computing device to transmit signals representative of a probability of tampering; wherein the token issuance determination engine maintaining the one or more electronic conditions is further configured to, based at least on a combination of the signals representative of a probability of tampering and the signals representative of a probability of tampering, cause the token customization unit to electronically customize the token blank to indicate that the token is potentially compromised.

In some embodiments, the token blank is customized by the token customization unit to electronically indicate one or more further acceptance conditions, including at least one of a duration of enhanced scrutiny and a duration of reduced capabilities. In some embodiments, the token blank is customized by the token customization unit to physically indicate using indentions on the token blank one or more further acceptance conditions, including at least one of a duration of enhanced scrutiny and a duration of reduced capabilities.

In some embodiments, the automated kiosk system is operated by a remote operator connected through the secure networking connection, the remote operator interacting with the token requester through a video link established through the user interface, wherein the user interface maintains a video record of interactions between the remote operator and the token requester; and wherein the video record of interactions is contemporaneously processed by the backend platform to automatically detect one or more abnormalities in the video record relative to a population set of video records of other interactions; and wherein the one or more electronic conditions applied by the verification unit includes at least one condition adapted to reject or conditionally approve the token request at least based on the detected one or more abnormalities.

In some embodiments, the automated kiosk system further comprises a remote inspection unit configured to provide a token video feed for visual inspection the token for embossing and indenting errors by at least one of the remote operator or one or more internal sensors prior to release of token by the automated kiosk system.

In another aspect, a method is provided, the method contemporaneously provides a token upon receiving a token provisioning request by an automated kiosk system situated in a non-secure environment, the token issued by a token issuance authority having customized machine readable data stored thereon, the method comprising: initiating, at a user interface of a first computing device, request signals for the token for a token requester including at least electronic indicia of credentials provided by the token requester; establishing one or more communication links between the first computing device and a backend platform; transmitting the electronic indicia of credentials to a backend platform across a secure networking connection including at least the one or more communication links between the first computing device and the backend platform, the secure networking connection adapted to communicate validation and credential information; receiving by the backend platform through the secure networking connection, the electronic indicia of credentials from the first computing device; maintaining, on the backend platform, one or more electronic conditions based at least on requirements provided by the token issuance authority; and applying, by the backend platform, the one or more electronic conditions, whether a token requester is approved for the requested token, receiving, by first computing device, in response to the transmission of the electronic indicia of credentials, electronic indicia of a provisioning determination; and receiving a token blank from a token feed chamber and upon the first computing device receiving a positive electronic indicia of the provisioning determination, customizing the token blank by ascribing customized machine readable data based at least on the electronic indicia of credentials provided by the token requester on the token blank.

In some embodiments, the token blank is customized using at least the received personal identification information obtained from a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, the second set of communication links bypassing the first computing device. In some embodiments, the token blank is customized using at least the received personal identification information obtained from a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, bypassing the first computing device; and wherein the backend platform is configured to receive personal identification information through the second set of communication links, and the application of the one or more electronic conditions by the verification unit uses at least on the received personal identification information.

In some embodiments, an anti-tampering unit configured to detect tampering attempts is provided for communication with at least one of the first computing device and the second computing device, and the method further comprises transmitting, by the anti-tampering unit, signals representative of a probability of tampering. In some embodiments, an anti-spoofing unit configured to detect spoofing attempts is provided for communication with at least one of the first computing device and the second computing device, and the method further comprises transmitting, by the anti-spoofing unit, signals representative of a probability of tampering. In some embodiments, the method further comprises: causing the token customization unit to electronically customize the token blank to indicate that the token is potentially compromised upon a determination of a potentially compromised security based at least on signals received from the anti-tampering unit and the anti-spoofing unit. In some embodiments, the token blank is customized by the token customization unit to electronically indicate one or more further acceptance conditions, including at least one of a duration of enhanced scrutiny and a duration of reduced capabilities. In some embodiments, the token blank is customized by the token customization unit to physically indicate using indentions on the token blank one or more further acceptance conditions, including at least one of a duration of enhanced scrutiny and a duration of reduced capabilities.

In some embodiments, the method further comprises: recording a video record of the customized token during or after customization; automatically performing a visual inspection of the customized token by comparing one or more attributes of the customized token with a plurality of video records recorded in relation to a plurality of previous customized tokens; upon detecting one or more abnormalities in the customized token, rejecting the customized token and re-customizing a new token blank obtained from a token feeder.

In another aspect, a non-transitory computer readable medium is provided, the non-transitory computer storing machine-readable instructions, which when executed by a processor, cause the processor to perform steps of: initiating, at a user interface of a first computing device, request signals for the token for a token requester including at least electronic indicia of credentials provided by the token requester; establishing one or more communication links between the first computing device and a backend platform; transmitting the electronic indicia of credentials to a backend platform across a secure networking connection including at least the one or more communication links between the first computing device and the backend platform, the secure networking connection adapted to communicate validation and credential information; receiving by the backend platform through the secure networking connection, the electronic indicia of credentials from the first computing device; maintaining, on the backend platform, one or more electronic conditions based at least on requirements provided by the token issuance authority; and applying, by the backend platform, the one or more electronic conditions, whether a token requester is approved for the requested token, receiving, by first computing device, in response to the transmission of the electronic indicia of credentials, electronic indicia of a provisioning determination; receiving a token blank from a token feed chamber; and upon the first computing device receiving a positive electronic indicia of the provisioning determination, customizing the token blank by ascribing customized machine readable data based at least on the electronic indicia of credentials provided by the token requester on the token blank.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a high level block diagram illustrating an example ecosystem, according to some embodiments.

FIG. 2 is a schematic diagram illustrating components in a sample backend subsystem, according to some embodiments.

FIG. 3A is a block schematic diagram illustrating the client subsystem in further detail, according to some embodiments.

FIG. 3B is a block schematic diagram illustrating components of a system in more detail, according to some embodiments.

FIG. 4 provides a sample illustration of a process flow illustrative of information that may be communicated between various components of a system, according to some embodiments.

FIG. 5 is a sample workflow illustrating various steps taken by components of the system and/or other stakeholders, according to some embodiments.

FIG. 6 is an example workflow indicating, at a higher level of detail, specific function calls that may be invoked at various stages in the provisioning of various tokens, according to some embodiments.

FIG. 7A is an example workflow indicating, at a high level of detail, specific actions that may be taken by a user and a remote operator at various stages in the provisioning of tokens, according to some embodiments.

FIG. 7B is a continuation of the example workflow from FIG. 7A, continuing from the last step shown in FIG. 7A.

FIG. 7C is a continuation of the example workflow from FIGS. 7A and B, continuing from the last step shown in FIG. 7B.

FIG. 7D is a continuation of the example workflow from FIGS. 7A-C, continuing from the last step shown in FIG. 7C.

FIG. 8 provides an exemplary process flow where the client subsystem includes automated banking machine functionality, according to some embodiments.

FIG. 9 provides an environmental view showing a user interacting with the client subsystem, according to some embodiments.

FIG. 10A provides a top plan view of a client subsystem, according to some embodiments.

FIG. 10B provides a front elevation view of a client subsystem, according to some embodiments.

FIG. 10C provides a side cross-sectional view of a client subsystem, according to some embodiments.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Financial tokens are utilized to provide access to one or more financial products, or information regarding or associated with financial products. The financial products may include bank accounts, lines of credit, credit card accounts, charge card accounts, among others.

These financial tokens may include credit cards, bank cards, among others. These financial tokens include security authentication protocols adapted to eliminate and/or reduce the risk of unauthorized usage, and accordingly, stringent requirements are utilized, for example, to establish that “know your client” requirements are met prior to the issuance of such financial tokens.

An approach for provisioning physical financial tokens is the use of an operator-driven model where an individual enters the physical premises (e.g., a secured location) of an institution, and has his/her identification verified through manual means. In this secured location, there may be safeguards against PIN theft, video cameras recording transactions, specifically trained and authorized personnel, physical access restrictions, etc. These security measures are utilized because the financial tokens provided in such secured environments typically provide a deep level of access into the associated one or more financial products.

For example, a bank card issued at a bank may provide access at various ATMs and bank branches such that a person, with the bank card and some other identifying information, such as a PIN number or a password, is able to deposit, withdraw money, borrow money, etc. The high level of security at a physical bank branch provides a level of comfort to the bank such that the provisioning process is more trustworthy from a financial risk perspective. The physical bank branch would be able to control who has access to the bank, when the bank is open.

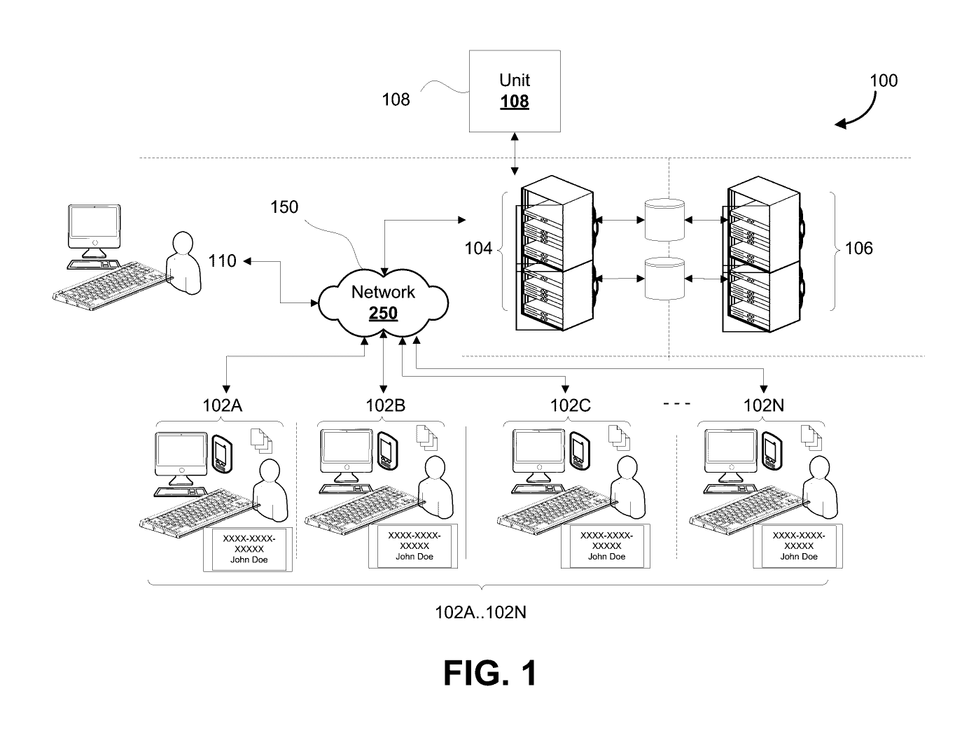

FIG. 1 is a high level block diagram illustrating an example ecosystem, according to some embodiments. A high level ecosystem overview is provided, wherein a system 100 is provided. The system 100 may be configured for provisioning (e.g., issuing, providing, generating, creating, customizing) tokens for individuals. These tokens may include, for example, debit cards, credit cards, identity cards, payment cards, membership cards, wireless fobs, rewards cards, among others. The system 100 may include various components, subsystems, units, modules, devices, etc., which may interoperate to facilitate provisioning and/or issuing various tokens. As a non-limiting example, the system 100 may be used for the “instant” (e.g., relatively quick relative to conventional approaches) issuance of a payment card, and the system may be configured for operation with no or minimal human operator guidance and various steps of verification and validation may be performed automatically or semi-automatically.

In a more specific embodiment, the system 100 provides an “instant” issuance solution configured to facilitate on-site payment card personalization for on-site payment card issuance and delivery through provisioning a payment card that is personalized and/or customized such that electronic data is written to the payment card (e.g., through embossing, indent, thermal printing, and/or encoding (on magnetic material and/or electronically writing data on the chip of payment cards)).

The tokens may be physical in nature, or virtual (e.g., provided on a suitably mobile device or other computing device, such as an AppleTM Passbook enabled card, an Apple PayTM configured card, a Google Wallet™ enabled payment card). The token may, in some embodiments, be associated with an existing account (e.g., a bank account), or may be used to open a new account. The token may be associated and/or customized based on various identifying information, personal information and/or circumstantial information associated with the provisioning of the token (e.g., time of provisioning, location, related transactions). In some embodiments, various business conditions may be implemented by the system 100 that may indicate characteristics of the features provided by the token, such as, but not limited to, credit limit, expiry date, maximum cash advance, etc.

Various embodiments of the system may be advantageous relative to conventional approaches and apparatuses for provisioning tokens. Conventional apparatuses for provisioning tokens include “canned solutions” that were adapted for a specific type of secure and/or trusted environment (e.g., at a bank), for use “in branch” (e.g., a bank branch, a financial institute), such that hardware/software sits within branch walls, behind the branch counter, operated by trusted individuals (e.g., bank employees), connected to a trusted network (e.g., a bank's network) having security equipment (e.g., video cameras), trained staff, contracts in place with employees, etc.

Conventional approaches for provisioning tokens required that an individual visit a trusted environment where a token may be provisioned directly, or requested a token through a cumbersome process wherein the individual sends in an application along with some verification information, and receives the token through, for example, courier or mail. For example, an individual fills out an application form for a credit card at the airport and the actual provisioning of the token (e.g., the individual receives the credit card in the mail) occurs several weeks later. Accordingly, a challenge with conventional approaches is that the requirement for verification and/or validation significantly increases the amount of time required and often, a large amount of time is required between application for a token and the provisioning and/or receipt of the token, unless the individual is physically proximate at a trusted location where verification can be conducted by trusted individuals, in a trusted environment.

For example, there are additional steps of validation, verification, etc., that may be required prior to the provisioning (e.g., issuance) of the token, and these steps often require cumbersome, manual, and resource intensive processes. There may be various regulatory requirements that have to be met prior to the issuance of a token (e.g., for financial-related tokens), and the tokens may require customization in relation to stored information thereon (e.g., magnetic stripes, inductive circuits, electronic “chips”, bar codes).

The process of obtaining a token that is customized for use in the context of various transactions can be time-consuming and may impair the ability to conveniently and effectively conduct transactions immediately after application and/or issuance. For example, if an individual wishes to apply for a credit card at a convenience store, the convenience store, without further equipment, may be unable to quickly obtain a credit card for that individual and further, the individual may be unable to continue a transaction in the convenience store, potentially dis-incentivizing the individual from making a purchase and/or applying for the credit card. The inability to provide an “instant issuance” of a token in public locations and/or environments is typically caused by technical obstacles from a verification, generation, and/or customization perspective, and lost business opportunities may result.

Extending the ability to provision tokens, especially tokens related to financial activity (e.g., credit cards, debit cards, charge cards) and/or other types of tokens requiring enhanced security (e.g., a passport, a NEXUS pass) in public environments has been difficult, if not impossible.

Accordingly, the system as described in some embodiments may be provided for the provisioning of tokens in public and/or insecure environments (e.g., out of branch issuance/printing of financial cards (credit or debit)). Various technological solutions are provided to overcome various technical obstacles faced by conventional approaches, including technological approaches to increasing trust associated with provisioning tokens in insecure and/or untrusted environments operated by less trustworthy and/or validated staff. Secure connections, anti-tamper/anti-spoofing units are example technologies applied to aid in overcoming some of these challenges. Aspects of some embodiments indicate when and how tokens are provisioned, and provide physical, tangible systems wherein tokens are customized for immediate use by a token requester.

There may be various advantages associated with some embodiments of the system, including, for example, the ability to provide and/or otherwise facilitate “out of branch” deployment, while meeting stakeholder requirements (e.g., requirements of a bank, card issuer, integrator); providing a solution (e.g., a customizable kiosk) flexible enough to accommodate specific requirements that may vary from stakeholder to stakeholder (or group of stakeholders to group of stakeholders); out of branch issuance/printing of tokens (e.g., cards), based on a workflow that is different from in branch workflow yet also requiring little to no modification of issuance workflow in bank/credit card company environment; and the ability for the system to be deployed (e.g., by providing and/or otherwise setting up the kiosk) to third party environments, and use relatively low cost external personnel, while maintaining trust and/or compliance.

By being able to provision tokens in public and/or insecure environments, individuals may be more incentivized to apply for various products and/or services, which may, for example, provide a significant boost to new financial card issuances. Further, these tokens may be issued in a way that they are likely to be used right away, providing a further benefit as relative to conventional approaches, there may be overall cost savings, including savings associated with relatively high cost of the issuance of a card that may not ever be used. Revenue associated with financial cards (especially credit cards) that might not have otherwise been fully issued/used may also be obtained using the system of some embodiments. The ability to provision cards from a point of manufacture (e.g., personalization) to print out may provide significant cost reductions.

Some embodiments of the system are designed such that a token can be provisioned (e.g., issued) temporally proximate to when the token is requested. The system may be configured to interoperate with various entities (e.g., financial institutions), third party systems, etc.

A client subsystem 102 (e.g., a kiosk environment) may be provided where an individual may be able to request a token (e.g., a credit card), and this client subsystem 102 may be provided in various locations. In some embodiments, the client subsystem 102 is provided in locations that have a lower level of security relative to an issuing institution (e.g., a financial institution, a bank, an issuing authority, a government, a corporation), such as a convenience store, a grocery store, a stadium, a movie theatre, an airport, etc. The client subsystem 102 may be provided in the form of various computing devices, and in some embodiments, is a suitably configured kiosk having a user interface (e.g., a screen, a device having various input/output capabilities). The client subsystem 102 may be operated by various individuals, such as specially trained kiosk operators, employees located at the location, by a token requester him or herself, or a combination of individuals.

The client subsystem 102 may connect, through a suitable networking connection, to a frontend subsystem 104 and/or a backend subsystem 106. In some embodiments, the frontend subsystem 104 and the backend subsystem 106 may be provided by the same computing device or set of computing devices, e.g., at a data center or as a set of a distributed networking resources (e.g., a cloud computing implementation). The backend subsystem may be associated with an issuing institution 108.

The frontend subsystem 104 may, in some embodiments, be configured to communicate various aspects of information with the kiosk environment (e.g., validation/verification responses, user identity information, credential information, among others). The frontend subsystem 104 may communicate information with the backend subsystem 106 in facilitating the provisioning of the token. The frontend subsystem 104 may, for example, be configured to adapt information to be provided to the client subsystem 102 that facilitates the provisioning and/or customization of the token (e.g., providing a set of electronic instructions that may be used to customize a token, such as a credit card such that it can be customized for use in relation to a particular financial account and/or product). The frontend subsystem 104 communicates information that aid in various required and/or regulated processes, such as “know your client” requirements, etc. The frontend subsystem 104 may also aid in the provisioning process by transmitting and/or receiving information required from a client identification perspective.

A backend subsystem 106 may be provided that may be a computing system or set of computing systems that may be secured and/or provide a higher level of security and/or trust. For example, the backend subsystem 106 may be a computing system associated with a financial institution, and may be administered such that only authorized personnel are able to access the backend subsystem 106 in a secured environment (e.g., having various secured communication features such as encrypted communications, physical security, redundant databases). The backend subsystem 106 may be configured to store and/or communicate sensitive information (e.g., financial account information, user identification information, financial products associated with an individual, institutional information, business conditions). The backend subsystem 106 may be configured to conduct various automated and/or semi-automated tasks, such as verification and/or validation, the application of conditions (e.g., lowering credit amount due to the provisioning at a low-security kiosk), etc. The backend subsystem 106 may be configured, for example, to communicate customer and account data with a secured party and/or computing systems associated with a secured party ultimately issuing the token, such as a financial institution. In some embodiments, the backend subsystem 106 is directly provided by the secured party and is not a separate system.

In some embodiments, the backend subsystem 106 may include various functional units, such as, for example, a temporary account generator, a financial account linkage unit, a token issuance determination engine (applying electronic conditions to vary parameters of cards provisioned), a notification engine, a risk assessment unit, a blacklist unit (e.g., to implement and/or otherwise provide a blacklist, a block list, a gray-list (conditions requiring greater scrutiny)), etc., among others. These functional units may be provided in the form of various software, hardware, firmware, and/or combinations of the same. Further, the functional units may be provided in the form of a distributed set of networking resources, such as a cloud-computing implementation.

In some embodiments, the client subsystem 102 connects, through a suitable networking connection, to a remote operator subsystem 110. The remote operator subsystem 110 may be configured to allow a remote kiosk operator to interact with a user located at the client subsystem 102. In some embodiments, the remote operator subsystem may provide audio and/or visual interaction between the remote operator and the user, such as a video conferencing channel. In some embodiments, this video interaction may be stored by the financial institution, for example, for quality assurance, fraud detection, or other purposes.

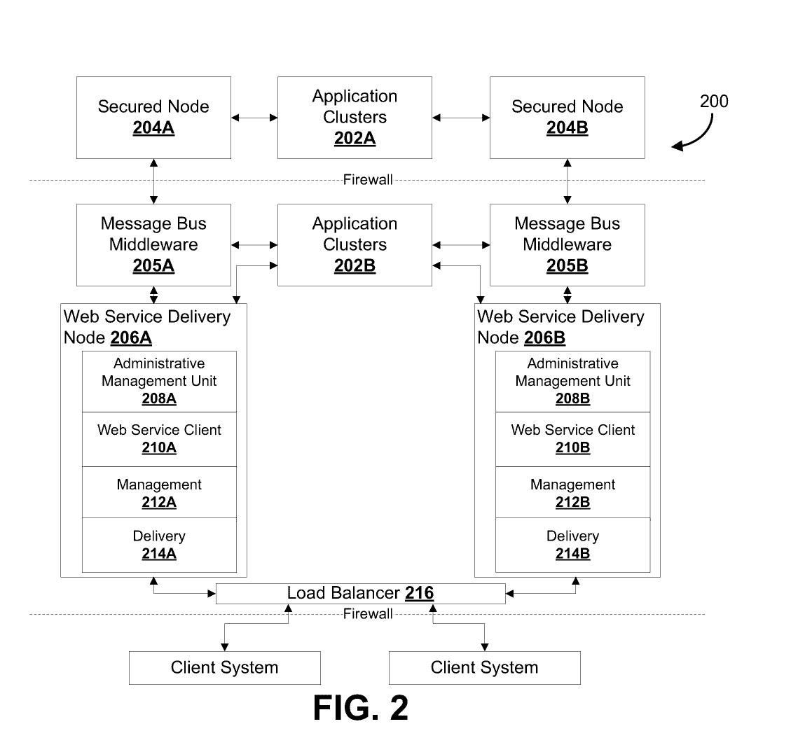

FIG. 2 is a schematic diagram illustrating components in a sample backend subsystem, according to some embodiments. The components shown are exemplary in nature, and provide details for some embodiments where the backend subsystems are configured to be deployed in a fully redundant architecture, designed not to have single points of failure and for horizontal scalability. As indicated in FIG. 2, the system may include various application clusters 202A, B that are utilized to provide the functionality of backend subsystem 106, and these may be associated with various secured nodes 204A and 204B, which may host various databases and/or informational stores of the token issuing authority and/or a financial institution. The application clusters 202A, B may be duplicated and/or otherwise held in a highly redundant and/or fault-tolerant architecture. In the example of FIG. 2, a mirrored architecture is provided, but other architectures are possible.

The application clusters 202A, B may be protected by various layers of firewalls, and may be configured to communicate through message bus middleware 205A, B. The frontend subsystem 104 may be accessible through one or more web service delivery nodes 206A, B, which, for example, may include aspects such as an administrative management unit 208A, B, a web service client 210A, B, a management unit 212A, B, a delivery unit 214A, B, etc. Distribution of computing resources may be, for example, balance between various resources and/or nodes through the use of a suitably configured load balancer 216.

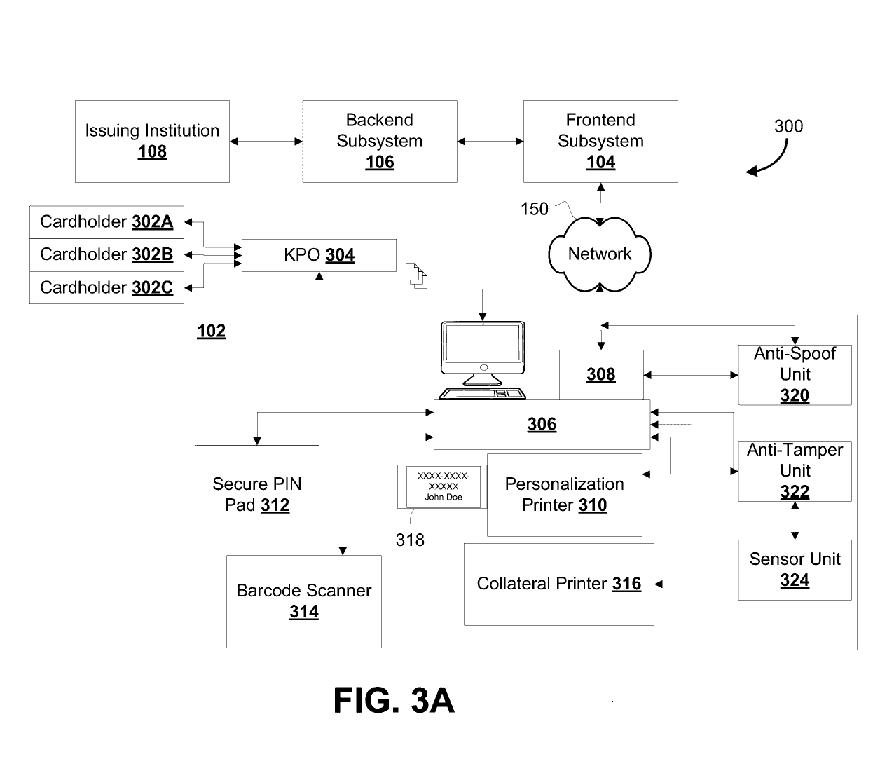

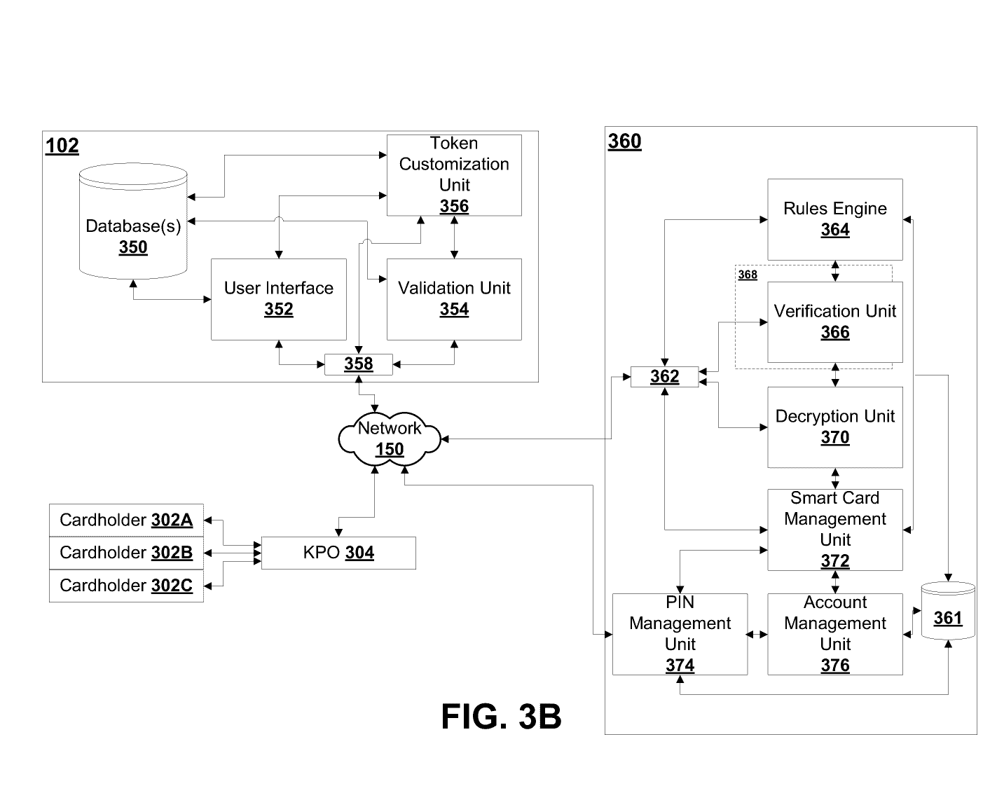

FIG. 3A is a block schematic diagram illustrating the client subsystem in further detail, according to some embodiments. The client subsystem 102, for example, may be provided in the form of a “kiosk in a kit”, and may include various computing devices, input interfaces, output interfaces (e.g., display interfaces), printers, among others. In some embodiments, the client subsystem 102 may be configured to provide tokens 318 to potential tokenholders (e.g., cardholders 302A, 302B, and 302C). In some embodiments, the client subsystem 102 may be configured for operation by an operator 304 (e.g., a Kiosk Print Operator). There may be other components, including network connection 308, pin pads 312, scanners 314, printers 316, etc. There may be a token issuance and/or personalization/customization unit 310, such as a Magtek ExpressCard 2000™. The client subsystem 102 may include software that may be used to personalize and/or issue the token, and may be configured to provide various functionality, such as software to guide the end-user through the process (e.g., from manually entering a driver's license ID through to card issuance), and may also include functionality to request restocking of the tokens, or to exchange various consumables.

In some embodiments, an anti-spoofing unit 320 may be provided, the anti-spoofing unit 320 configured to detect fraudulent, malicious and/or unauthorized network communications (e.g., a false response signal, a falsified acknowledgement). In some embodiments, an anti-tampering unit 322 may be provided, the anti-tampering unit 322 configured to detect fraudulent, malicious and/or unauthorized physical activities being performed against the client subsystem 102 (e.g., an individual trying to use a crowbar to break into a kiosk). The anti-spoofing unit 320 and/or the anti-tampering unit 322 may be configured such that an alert or other type of notification is generated when unauthorized activities or probable unauthorized activities are detected. The anti-tampering unit 322 may also be connected to various sensors provided by a sensor unit 324, the sensors utilized to detect various characteristics associated with the operation of the client subsystem 102.

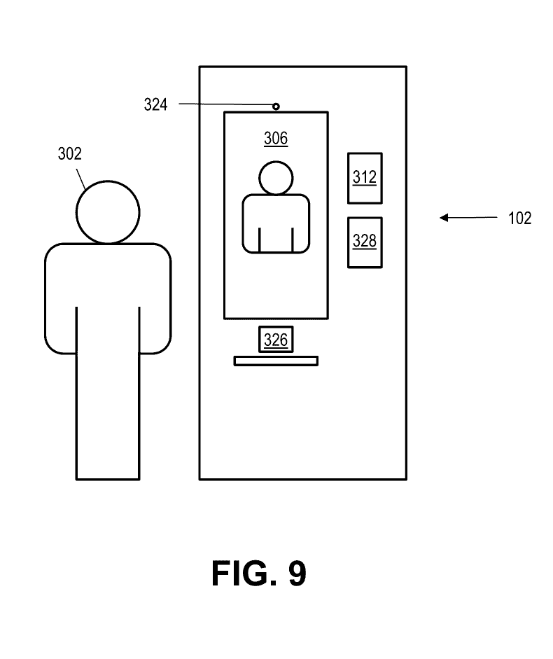

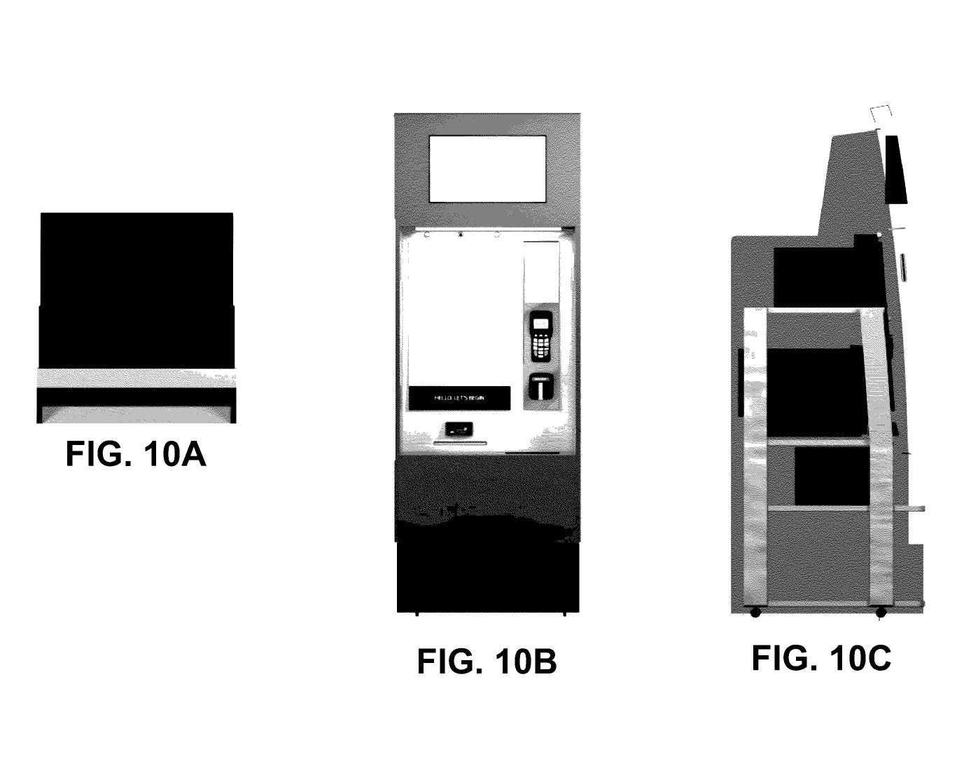

As shown in FIG. 9, in some embodiments, a token dispensing module 326 may be provided, the token dispensing module 326 may be configured to receive the tokens 318 from the token issuance and/or personalization/customization unit 310 for inspection. The inspected tokens 318 may be dispensed or rejected, for example, if the token 318 is faulty.

In some embodiments, an identification scanner 328, such as a 3M identification document reader, may be provided (as illustrated, for example, in FIG. 9). The identification scanner 328 may be configured to scan an identification document of the potential tokenholder. In some embodiments, the identification may be configured to verify the authenticity of the identification document (e.g. whether the identification is a forgery, expired, etc.). In some embodiments, information from the scanned identification document is provided to the remote operator subsystem 110 via network connection 308. The remote operator at the remote operator subsystem 110 can view information from the identification document. In some embodiments, the remote operator may visually verify that the customer is the person whose identification document was provided by accessing a camera of the client subsystem 102.

The client subsystem 102 may include a software and/or hardware based hardware abstraction layer, which may be utilized for generalizing various hardware models (e.g., card personalization machines, secure PIN pads, cryptographic tokens, unique identification validation). The client subsystem 102 may be connectable to the frontend subsystem 104, the backend subsystem 106 and/or the remote operator subsystem 110, and may include various networking interfaces that may be used for communications. In some embodiments, the communications may be adapted to be provided through a secured communication link. The customizable token 318 may include various types of objects, including pass cards, membership cards, key fobs, etc., that may have various data writable components such as magnetic strips, electronic circuitry, barcodes, etc. In some embodiments, the customizable token 318 may also include visual and/or tactile markers, such as printed text and/or braille script.

The client subsystem 102 may further include various anti-tampering and/or anti-spoofing components and/or features, for example, various cameras, tilt sensors, vibration sensors, temperature sensors, gyroscopes, location sensors (e.g., GPS locators, proximity beacons), accelerometers, microphones, proximity sensors, accelerometers, a case open sensor, a power loss sensor etc. Anti-spoofing features may be provided at various components and/or through the network, for example, a packet analyzer may be provided, firewalls may be suitably configured to prevent and/or track unauthorized usage/entry/access, source authentication units may be provided, etc.

The client subsystem 102 may further include a display. The display may be used to provide supplemental information (e.g. benefits of the token or advertisements) to the customer during the token provisioning process. In some embodiments, the interface 306 includes the display. In such embodiments, the interface may display the supplemental information before, during, or after the token provisioning process. The supplemental information may be provided on the interface in a split screen, an overlay, a picture-in-picture, etc. In some embodiments, the display is separate from the interface 306, and the supplemental information is displayed on the supplemental display.

FIG. 3B is a block schematic diagram illustrating components of a system in more detail, according to some embodiments. The client subsystem 102 may include, for example, a first computing device having a first processor, first computer readable memories and first data storage 350.

There may be various units provided, such as a user interface 352 for use by the kiosk operator to initiate provisioning of the token for a token requester, the user interface configured to receive electronic indicia of credentials provided by the token requesters 302A-C; and a validation unit 354 configured to transmit the electronic indicia of credentials to a backend platform and to receive, in response to the transmission of the electronic indicia of credentials, electronic indicia of a provisioning determination; a token customization unit 356 configured to, upon the computing device receiving a positive electronic indicia of the provisioning determination, customize a token blank by ascribing customized machine readable data based at least on the electronic indicia of credentials provided by the token requester on the virtual token blank; and a network connection unit 358 configured for establishing one or more communication links between the first computing device and the backend platform.

The network connection unit 358 may provision for use a secure networking connection including at least the one or more communication links between the computing device and a backend platform, the secure networking connection adapted to communicate validation and credential information. The frontend and/or backend systems may be provided in the form of the backend platform 360, which may, for example, be comprised of a second computing device having a second processor, second computer readable memories and second data storage 361. The backend platform 360 may include, for example, a receiver unit 362 configured to receive, through the secure networking connection, the electronic indicia of credentials from the kiosk; a token issuance determination engine 364, configured to maintain, on the second data storage, one or more electronic conditions based at least on requirements provided by the token issuance authority; and a verification unit 366, configured to determine, by applying the one or more electronic conditions, whether a token requester is approved for the requested token. The verification unit 366 may be provided in the context of a high-security module 368. The backend platform 360 may also include a decryption unit 370, a smart card management unit 372 configured for keeping track of provisioned tokens (e.g., chips, chip data, magnetic strip data associated with each customer), a PIN management system 374 configured to securely track, store, monitor and/or provision PINs for informational exchange with backend infrastructure (e.g., banking infrastructure for interoperation with various financial accounts), and an account management unit 376. The account management unit 376 may be configured to manage account details, and in some embodiments, generate and/or cause the provisioning of one or more temporary accounts associated with a provisioned token. In some embodiments, the token issuance

In some embodiments, a remote operator connected through the secure networking connection operates the system. The remote operator may interact with the token requesters 302A-C through a video link established through the user interface 352, wherein the user interface maintains a video record of interactions between the remote operator and the token requester. The video record may be contemporaneously processed by the backend platform 360 to automatically detect one or more abnormalities in the video record relative to a population set of video records of other interactions.

The use of temporary accounts may help facilitate the process as such accounts may be utilized as a transitory and/or transient account for further downstream verification and/or validation processes with known and/or existing financial accounts (e.g., provisioning a card now having a temporary account especially where verification and/or validation is a slow or cumbersome process). In some embodiments, a new financial account may be generated based on a temporary account over a period of time (e.g., the customer has no pre-existing relationship with the issuing authority).

### PIN Set Process and Example Workflow

In some embodiments, a personal identification entry device 312 (e.g., a PIN pad) is provided as part of the system. In conventional systems, a problem for “instant issuance”, at least in Canada, was that a PIN was required to be set while a customer account was being created, in connection with smart card management (e.g., provided by an integrator such as Total System Services TSYS™ to manage processes as between bank and card issuer).

The requirement of having the PIN live during the account creation may be overcome by some embodiments. The system 100 may be configured to modify the normal sequence of creation of the PIN relative to the card issuance/activation, and one example of the overall workflow can be described as follows, where the token 318 is associated with a financial product provided by a bank, and a user interface 306 on the kiosk is provided by a tablet computer (or a computing device providing an interface associated with the kiosk).

In this workflow, a customer applies for a financial product on the tablet. The tablet sends the information to a bank associated with the product for adjudication. Adjudication may vary from bank to bank, but generally, the bank's systems will obtain certain information, from credit bureaus for example, and apply one or more credit scoring systems, and construct a response to the request for the financial product.

The response provided may be a “YES”, “NO”, or “possibly YES” (e.g., subject to for example a lower credit limit, or different interest rate). For example, some of the parameters of the response from the adjudication process may require further sign-off at the out of branch location, and conditions associated with adjudication could vary from location to location, or from time to time. In some embodiments, the initial information from the tablet may include information regarding the location/time of request etc. If there is approval, the bank may generate a temporary account. A response may be sent back to the tablet. Note the tablet will likely be operated by a “less trusted” employee, so the role of the tablet in the overall solution may be relatively limited.

Generally, the customer will provide various credentials, such as identity information (e.g., driver's license, photo identification, passport number, social security number). In some embodiments, this information may be taken by an operator (e.g., a Kiosk Print Operator, or KPO), and the KPO may verify that information (as provided for example to the tablet). In some embodiments, the KPO may be required to enter that specific information. In some embodiments, the identity information is entered using the identification scanner 328. In such embodiments, the information may be sent to a Remote Kiosk Print Operator (RKPO) located at a remote operator subsystem 326 to verification. Information may be communicated from the kiosk to the bank, and there may be variations in the particular steps of information input, validation, and/or confirmation.

In alternate embodiments, a bank system analyzes the identifying information and compares it to the temporary account; the bank may verify the information against other databases/systems. This may result in verification of the temporary account.

Information associated with the now authorized client may be sent back to the kiosk. In an embodiment, the information is presented on the user interface (e.g., the laptop). KPO may verify the information, and initiate the PIN set function.

Client may utilize the PIN pad 312 to set a PIN associated with the card (this may be conducted prior to printing of the card). The kiosk may include software that communicates solely with the PIN pad 312. In some embodiments, the PIN pad 312 may be separate from the interface 306 and may connect to the backend platform 360 via the network 150 using a secured network connection separate from a network connection (or secure network connection) between the interface 306 and the backend platform 360.

The kiosk software may be configured to ensure that the PIN (and associated information, called the PIN block—which may include information associated with the kiosk, so the kiosk can be located to complete the instant activation) is encrypted by an encryption key that may be embedded into the key pad 312 (and for which only a particular institution (e.g., a bank) has the key necessary for decryption). The kiosk may, for example, enable this encryption process. Various encryption techniques may be utilized, such as a combination of public and private keys, etc.

Once the PIN block is sent over to the institution's (e.g., the bank) server, the institution assembles various required information (e.g., a PIN, customer details, account details (potentially created by the institution).

The information may be encapsulated as an encrypted personalized package, and then the package may be configured for transmission to various parties. In some embodiments, information required to print the card may be provided to the client subsystem 102 (e.g., through laptop software) and may include various identifying information, that, for example, aids client subsystem 102 to find the right laptop/software instance. The provided information may be decrypted and provided to the token issuance and/or personalization/customization unit 310, which personalizes/embosses the card.

When the token 318 is provisioned, an inspection may be performed to ensure that the token 318 printed correctly. In some embodiments, the KPO or RKPO may perform a check (e.g., an optical check). In some embodiments, the token 318 is received by the token dispensing module 326, which may be configured to inspect the token 318. In such embodiments, the token dispensing module may include sensors, such as cameras, to inspect the token. The sensor data may be used to determine whether the token was printed correctly. In some embodiments, the sensor data is sent to the remote operator subsystem 110, where the RKPO can view the sensor data to determine whether the token was printed correctly. If the card did not print out correctly, then a reject process may be initiated.

In some embodiments, the client subsystem 102 is configured to include a requirement whereby the KPO must at the end click an activate button (could be on the software). In contrast, conventional solutions would ordinarily require activation on a device within a secured network (e.g., a POS or a bank machine). A difference provided by some embodiments is that an exception in the card issuer's payment card industry (PCI) standard's rules may be utilized to remove the requirement for activation on a device within a secured network.

A rejection process may be provided wherein a rejected card may be handled at the client subsystem 102. The client subsystem 102 may, for example, be locked down (e.g., having various functionality disabled and/or physical access restricted) unless a trusted party and/or a technician performs an activity to restore functionality. In some embodiments, such an activity may require dual authentication (e.g., by two trusted people present). In some embodiments, if the KPO determines that there was an error in the printing of the token, or for example the blank token was defective, then the token may be reinserted manually, where it is read by the kiosk and information is sent for verification by the issuing institution, namely that the token information is the last token information sent to the particular kiosk. If the answer is YES, then and only then this token can be reinserted into the printer, and it will be accepted and stored by the printer, for handling/disposal by an authorized person. Otherwise in some embodiments, the client subsystem 102 may be configured to automatically shut down. In some embodiments, where the inspection of the token occurs within the token dispensing module 326 and there was an error in the printing of the token, the token may be rejected within the client subsystem 102, for example, inside a secure disposal unit within the client subsystem 102.

Various advantages may be provided, for example, to mitigate potential risk where a defective card is physically kept for malicious purposes (e.g., an operator puts it in their pocket, passes on the card to the client and/or indicates that it was defective and prints another card). For example, if a card rejection occurs, in some embodiments, a district manager or technician may be required to retrieve the card immediately, for destruction (which may vary, for example, based on card issuer conditions). In some embodiments, there may be processes where the defective card is destroyed under camera supervision, etc.

### Secure Network Connection

In some embodiments, a secure network connection may be provided and/or otherwise utilized to facilitate the secure communication of information between various components of the system and/or external systems. For example, the sensitive and/or confidential information may be provided in relation to customer account information, financial system authentication protocols. Network connectivity may include, for example, the use of various types of secured communication protocols and/or encryption. In the context of “instant” activation and/or provisioning of customized cards, the secured network connection may be a significant aspect in relation to being able to provide a quick and convenient authentication and/or authorization process. In some embodiments, the secured protocols may vary, for example, depending on the requirements of a payment card issuer, a financial institution, regulatory bodies, local and/or jurisdictional laws, privacy requirements, etc.

The secure network connection may be uni-directional or bi-directional, and information may be padded with tracking information, fraud detection information (e.g., false entries used for identifying malicious access), etc. The secure network connection may utilize various types of encryption and/or obfuscation methodologies, such as the use of various private/public-key architecture protocols, etc., such that information may be encrypted on one end and decrypted on another.

For example, there may be various connection types utilized in providing secured network connection 150 between various components, such as frontend subsystem 106, networking interface 308, etc. In some embodiments, an anti-spoofing unit 320 is provided to intercept and/or otherwise monitor traffic flow through the secured network connection 150.

As non-limiting examples, the connection types used by the system (e.g., an instant issuance kiosk) may include:
(a) network protocol TCP/IP—provided between a terminal/user interface 306 (e.g., on a laptop) to a router 308; between the terminal/user interface 306 (e.g., on a laptop) to the personalization printer 310 (e.g., through the router 308), between the terminal/user interface 306 (e.g., on a laptop) to security subsystem (e.g., anti-tamper unit 322) through router 308;
(b) cellular network—a cost effective and stable connection may be provided, for example, where the system and/or kiosk may be a portable implementation (e.g., not necessarily residing at one particular physical location). Such a connection may be used, for example, between the router 308 to client backend subsystem 106. In some embodiments, an encrypted connection may be utilized (e.g., a 256 bit encrypted VPN connection over cellular); and
(c) a physical wire cable interface (e.g., a USB or ethernet cable) may be provided as a stable form of connection between components or subsystems, such as between the terminal/user interface 306 (e.g., on a laptop) to a PIN pad 312, from the terminal/user interface 306 (e.g., on a laptop) to a paper printer (e.g., a laser printer/collateral printer) 316, between the client subsystem 102 and the remote operator subsystem 110, etc.

Various types of connections may be used individually or in combination. In some embodiments, a back-up or secondary connection type may be provided. In some embodiments, information may be transmitted in a redundant fashion across multiple connection types, or validation information may be used and transmitted such information may primarily be transmitted over a first connection type, and validation information transmitted over a second connection type (e.g., the sending of parity bits/hash computations to ensure integrity of the information transmitted over the first connection type).

### Remote Operation

In some embodiments, a remote operator subsystem 110 may be provided, the remote operator subsystem configured to allow a remote operator to interact with a user operating the client subsystem 102.

The remote operator subsystem 110 may be configured to communicate over the network 150 with the client subsystem 102. In some embodiments, the remote operator subsystem is configured to receive information from components of the client subsystem 102, such as the identification scanner 328, the token dispensing module 326, and the sensors 324 (see, for example, FIG. 9).

For example, in some embodiments, the remote operator subsystem 110 receives audio and/or visual information from sensors 324 to allow a remote operator the ability to see and hear the user at the client subsystem 102. In some embodiments, the remote operator subsystem includes sensors, such as cameras and microphones, such that a video conferencing channel can be established. In some embodiments, this video interaction may be stored by the financial institution, for example, for quality assurance, fraud detection, or other purposes.

In some embodiments, the remote operator at the remote operator subsystem 110 receives information from an identification document scanned by the identification scanner 328. The remote operator at the remote operator subsystem 110 can visually verify that the potential tokenholder is the person identified in the identification document by accessing the sensors 324.

In some embodiments, the remote operator at the remote operator subsystem 110 can inspect a printed token 318 (e.g. for embossing or indenting errors) received by the token dispensing module 326 via sensors in the token dispensing module. If the printed token 318 is faulty, the remote operator can prevent the token dispensing module 326 may send an alert, for example, to the client subsystem 102. In some embodiments, upon receipt of the alert, the client subsystem 102 prevents the token dispensing module 326 from dispensing the token 318. For example, the token dispensing module may include a locking mechanism, or a reject mechanism that will move the token into a reject area within the client subsystem 102 for disposal. In some embodiments, if the token 318 is rejected, a new token 318 may be reprinted from a new blank token. In some embodiments, the printed token 318 is held by the token dispensing module 326 until a remote operator inspects the token and allows it to be released. For example, the token dispensing module may include a locked compartment that receives the token, the locked compartment may be unlocked by the remote operator upon verification that the token is not faulty.

In some embodiments, before issuing the token 318, a potential tokenholder must read and agree to terms and conditions of the institution issuing the token. In such embodiments, the terms and conditions may be provided to the potential tokenholder by printer 316. The potential tokenholder can then indicate their agreement via the interface 306. In some embodiments, the sensors 324 can record the potential tokenholder removing the printed terms and conditions from the printer 316. In some embodiments, the remote operator can observe the removal of the terms and conditions.

In some embodiments, the client subsystem 102 is toggleable between a locked mode and an unlocked mode. In the locked mode, functionality of the client subsystem cannot be accessed without the entry of a valid code. In the unlocked mode, the client subsystem 102 becomes active and allows for a user to access the functionality of the client subsystem. For example, a sales representative located at the client subsystem may have a valid code for unlocking the client subsystem. A potential tokenholder is directed to the client subsystem by the sales representative, who unlocks the client subsystem. In some embodiments, the entry of the code sends an alert to the remote operator subsystem 110 such that the remote operator becomes aware that the potential tokenholder is accessing the client subsystem 102 and can assist the potential tokenholder in the provision of the token 318. In some embodiments, the client subsystem 102 and the remote operator subsystem 110 include a direct communication tool, such as a hardwired telephone line, that allows communication between the potential tokenholder and the remote operator, for example, in cases when the network 150 experiences an error or outage.

In some embodiments, the remote operator subsystem 110 can interact with multiple client subsystems 102A, 102B . . . 102N. For example, the remote operator may be interacting with the multiple client subsystems simultaneously, sequentially, or a combination thereof. This may allow a remote operator to interact with clients at multiple locations. In some embodiments, more than one remote operator subsystem 110 is provided, and when the client subsystem initiates the token provisioning process, the client subsystem will identify a remote operator that is available.

### Anti-Tampering

In some embodiments, an anti-tampering unit 322 may be provided, the anti-tampering unit 322 configured to detect fraudulent, malicious and/or unauthorized physical activities being performed against the client subsystem 102 (e.g., an individual trying to use a crowbar to break into a kiosk). The anti-tampering unit 322 may also be connected to various sensors provided by a sensor unit 324, the sensors utilized to detect various characteristics associated with the operation of the client subsystem 102.

For example, where the client subsystem 102 is in the form of a kiosk, the kiosk may be designed so that in order to open it (without triggering tamper controls that result in shut down/escalation) dual control is required (two authorized personnel) to access un-personalized cards and/or rejected card.

Various other security features may be provided. For example, a camera may be included, which may be configured to track and/or monitor hand movements of operators, individuals, etc. Movements and activities can be tracked for various durations. For example, the camera may track when a KPO or customer takes a token from the printer, removes the terms and conditions from the laser printer, when removed to be packaged to the customer (some aspects out of range) or if KPO comes back to put in a reject, and/or performs a card swap.

The kiosk may be configured for location tracking (e.g., GPS, proximity beacons, W-Fi/cellular signal triangulation), for example, determining when the kiosk is outside of a building, etc. Various types of technology may be utilized, such as indoor localization technologies, geofencing, etc. to make sure kiosk is in the right location, and also issue various alerts and notifications if it the kiosk moved outside defined boundaries.

In some embodiments, a tilt sensor may be provided to detect when and/or if the kiosk is moved or jostled. For example, the kiosk may be configured to ping the KPO and provide various elements of information, such as a timestamp, amplitude of disturbance, etc. There may be various conditions included, such as an escalation (e.g., by notifying supervisors, police, security staff) if outside of office hours, different levels of alarm depending on location, etc. Kiosks may be location tracked, e.g., if the kiosk itself is stolen. In some embodiments, a USB token (e.g., having a time-sensitive passcode for multi-factor authentication) may be required to run aspects of the client subsystem 102, etc.

In some embodiments, the anti-tampering unit 322, upon receiving a signal from sensor unit 324 indicating that there is a risk that the client subsystem 102 has been tampered with, may send a signal to the token issuance determination engine such that a token subsequently issued is customized to include an indicia that the token is potentially compromised. Such indicia may indicate that one or more further acceptance conditions are applied, for example, a duration of enhanced scrutiny and a duration of reduced capabilities.

### ABM Integration

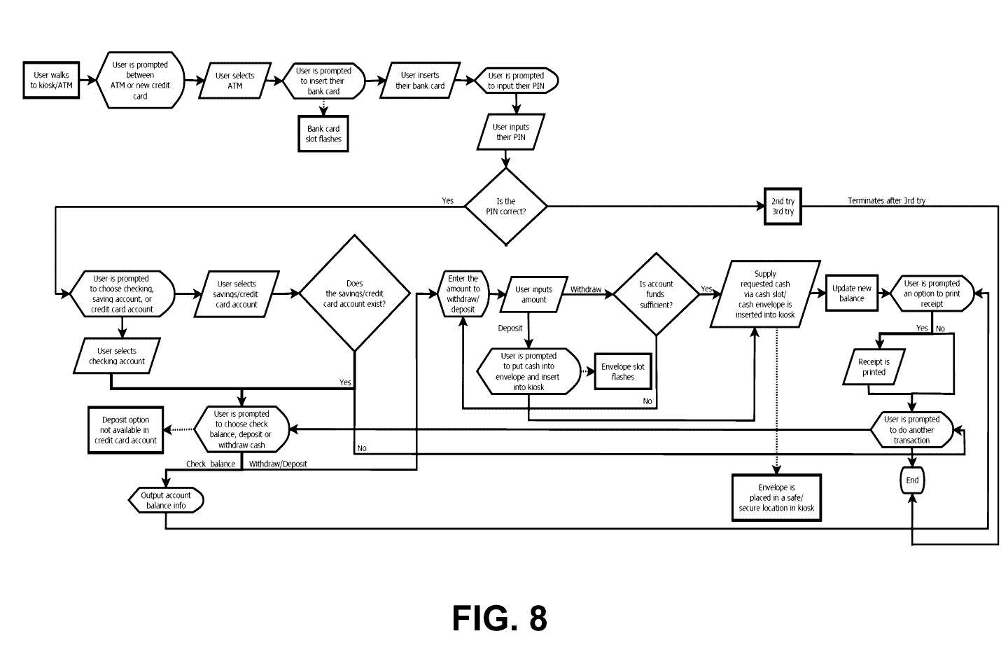

The client subsystem 102 may be toggleable between an automated banking machine (ABM) mode and a new card provisional mode. In some embodiments, the client subsystem 102 provides a user with the opportunity to toggle between the two modes. FIG. 8 provides a sample flowchart showing a client subsystem 102 operating in ABM/ATM mode. Client subsystems 102 with integrated ABM/ATM modes may allow customers to obtain a token and access their accounts with the token. For example, if a banking customer loses their bank card and requires cash, they may be able to obtain a replacement bank card and withdraw cash from their banking account at a single location, using a single system for both tasks. Financial institutions may also be able to consolidate their capital purchases, reducing the amount of separate pieces of equipment purchased.

### Example Workflows

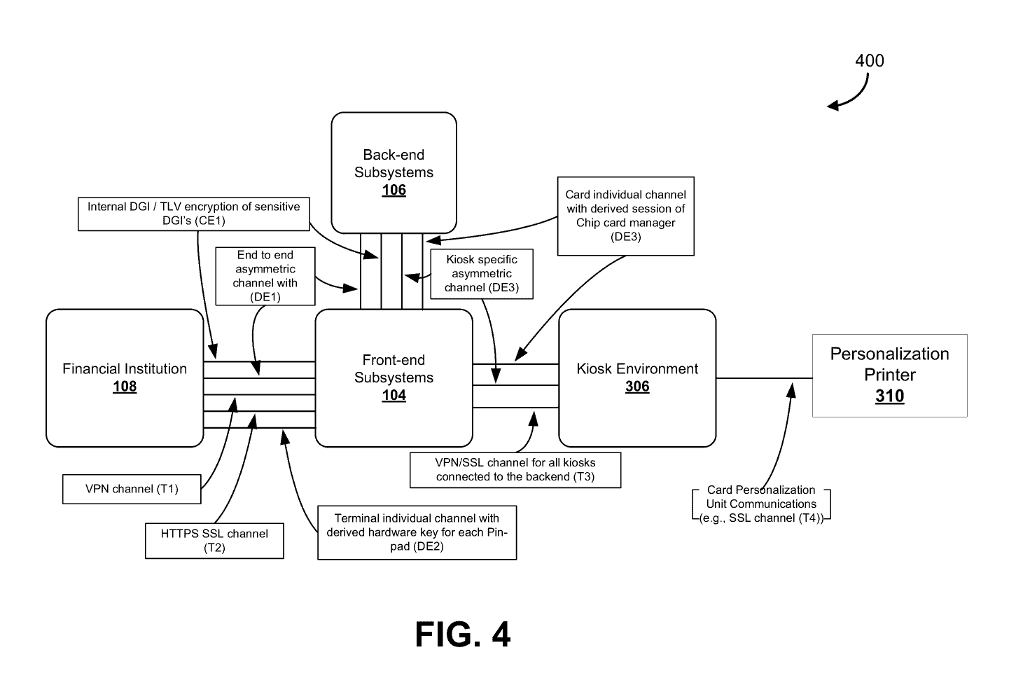

FIG. 4 provides a sample illustration 400 of information flow that may be communicated between various components of a system, according to some embodiments. The system may be configured to provide virtual token, issued by a token issuance authority such as a financial institution, the virtual token having customized machine readable data stored thereon and the system adapted for use by a kiosk operator. In this particular example, a financial institution is indicated as an example.

The details provided are illustrative and are not meant to be limiting. The financial institution 108 may establish various communication channels with the frontend subsystems 104, including various asymmetric channels, virtual private network (VPN) channels, and

Secure Sockets Layer (SSL) channels. For each PIN pad, there may also be an individual terminal channel with a derived hardware key. Such an embodiment may assist with ensuring a higher level of security as it relates to the use and/or transfer of PIN-related information, especially where such information is utilized as a secondary verification pathway in non-secure provisioning environments (e.g., in a convenience store environment where PIN information may need to be transferred separately in view of the level of security available for regular network communications).

The frontend subsystems 104 may be in communication with the backend subsystems 106, including the provisioning of encrypted channels, asymmetric channels, kiosk-specific asymmetric channels, and card individual channels having derived and/or dedicated sessions that may provide for improved security.

The kiosk environment 306 may be connected with the kiosk specific channels, and in some embodiments, a further VPN/SSL channel where kiosks are connected to the backend subsystems 106. The kiosk environment 306 may also communicate with the personalization printer 310, for example, providing personalization unit communications (e.g., instructions for personalization on to a chip, magnetic stripe, or other type of computer-readable media).

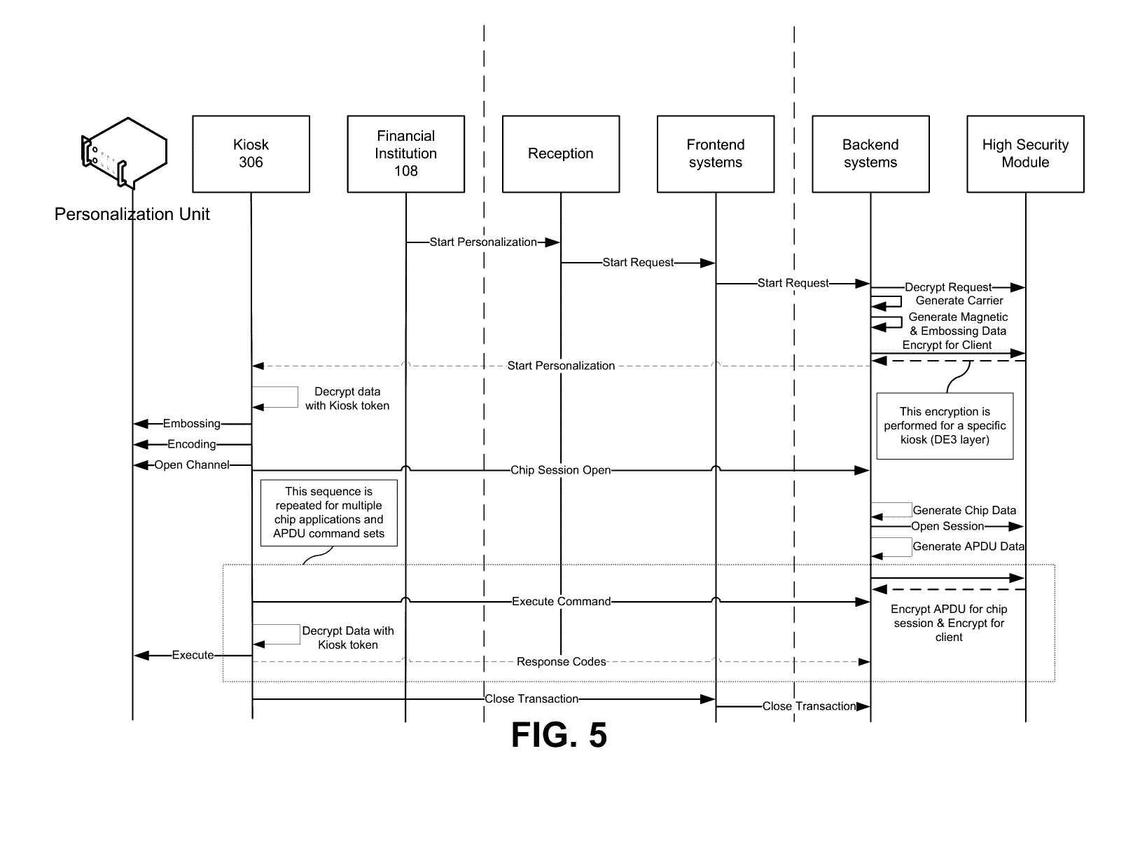

FIG. 5 is a sample workflow illustrating various steps taken by components of the system and/or other stakeholders, according to some embodiments.

The particular example is meant to be non-limiting and provided for illustrative purposes. FIG. 5 is an illustration of the client subsystem (e.g., a kiosk) startup procedure). After the kiosk session has been successfully established, a kiosk token may be unlocked and the End-To-End encryption layer (DE3 channel) can be established.

Various levels of personalization and requests are provided along the components of the system. Each level may include, for example, differing requirements in relation to security and/or identifying information, and the workflow 500 illustrates data flow that may initiate with a kiosk 306 or a financial institution 108 initiating a request for personalization, which is provided to a receiving aspect of the frontend subsystem 104 for transfer to a relatively more secured backend subsystem 106.

The backend subsystem may include various modules and/or units, which may decrypt the request, generate carrier signals, generate personalization information (e.g., magnetic strip data, chip configurations, access codes), etc. The generation of the personalization information may be encrypted on a kiosk-specific basis, so that only a particular kiosk and/or personalization printer 310 may be able to generate a specific token, for example, helping improve a level of security in relation to the provisioning of tokens. The backend subsystem 106 may generate smart-card specific data, for example, using application protocol data units (APDUs), etc.

The backend subsystem 106 may also compare the request against various blacklist servers and/or block lists that may, for example, have lists and/or records of accounts which should not be created (e.g., being associated with malicious or fraudulent use). In some embodiments, the backend subsystem 106 may also include various types of “gray lists”, wherein specific criteria may be indicative of fraudulent or malicious use, but not conclusive, and for example, may determine a score indicative of at least one of a probability and a financial impact of misuse. If a transaction request has a score greater than a threshold, the request may, for example, be denied, or aspects of the transaction may be changed (e.g., reducing an amount of credit provisioned in the request, requiring more identification to be provided, indicating a “flag status” on the token), etc.

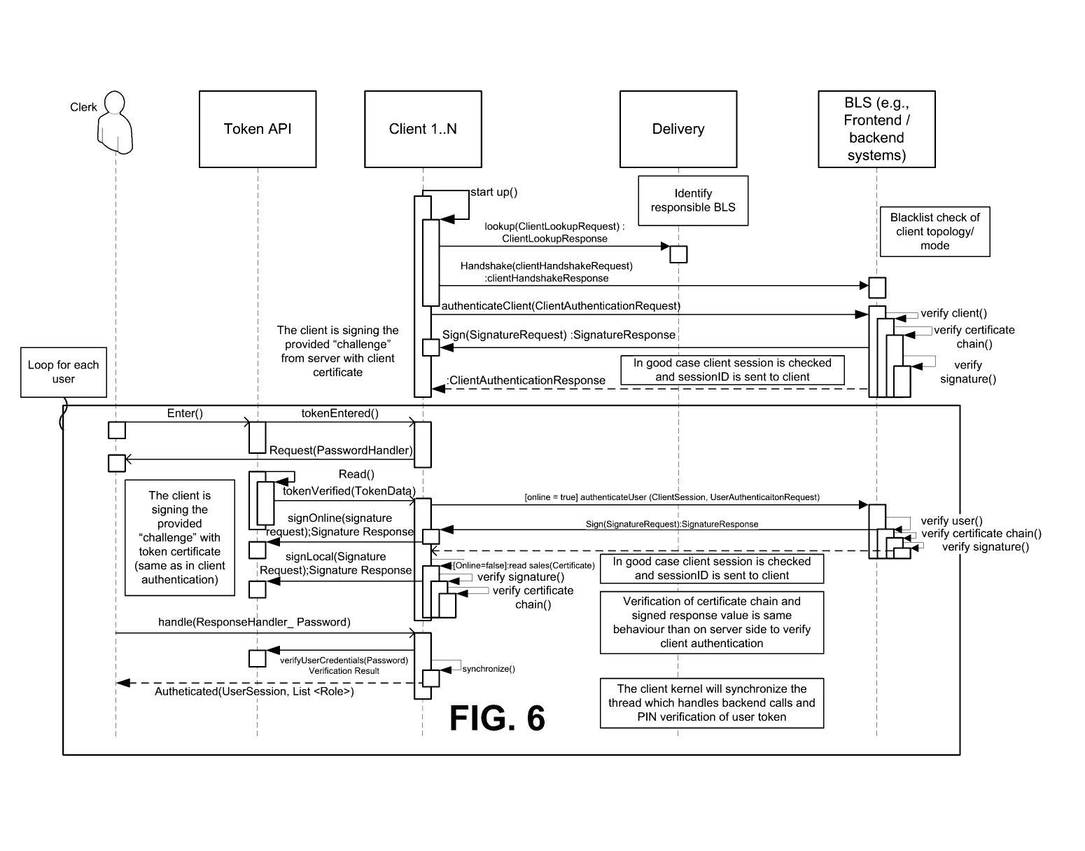

FIG. 6 is an example workflow 600 indicating, at a higher level of detail, specific function calls that may be invoked at various stages in the provisioning of various tokens, according to some embodiments. FIG. 6 illustrates an example user authentication procedure on a previously unlocked kiosk, for example, unlocked as per FIG. 5.

There may be various steps of handshaking, challenges, signing authority verification and/or blacklist checks as indicated in FIG. 6. The particular steps provided by FIG. 6 may vary, for example, based on specific requirements of financial institutions/regulators, a level of financial risk, a level of security and/or trust of individuals utilizing (e.g., token requesters) and/or providing access/usage (e.g., kiosk operators), kiosk environments (e.g., the availability of security cameras). Further, as indicated above in relation to FIG. 5, the specific function calls may not always provide a simple provision/not provision result, but rather, there may be varying types of provisioning that may be performed, for example, indicative of a limited provisioning and/or reduced available amounts of credit.

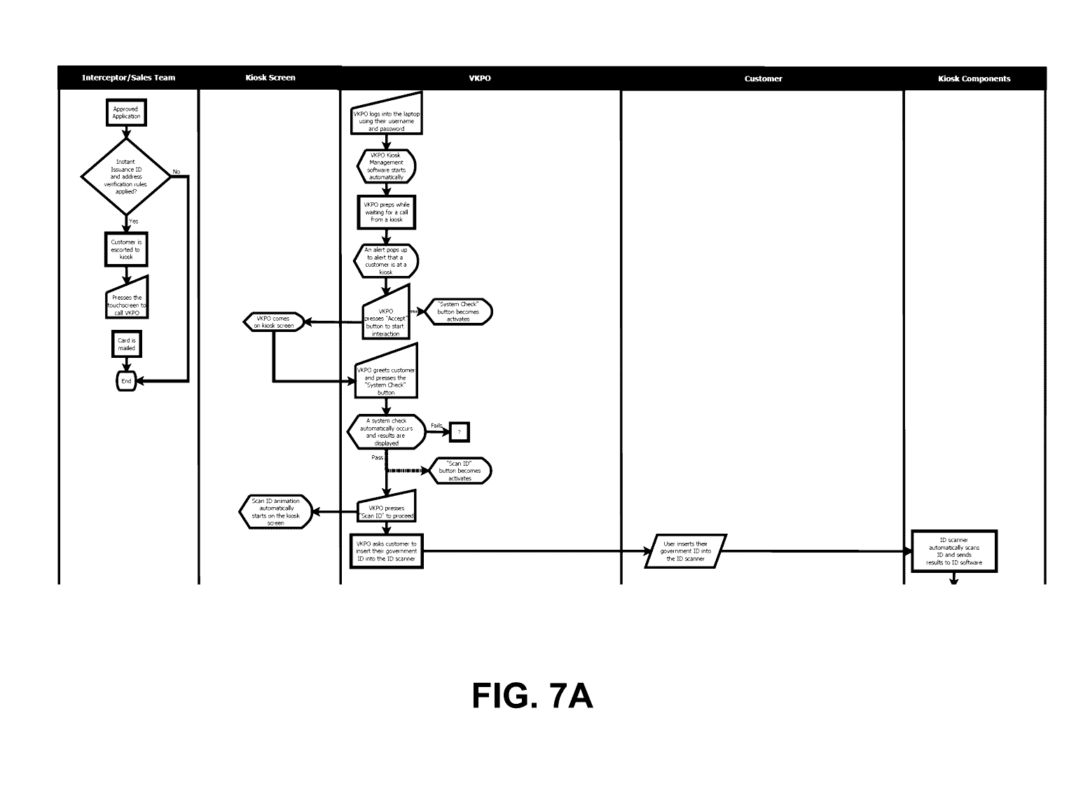

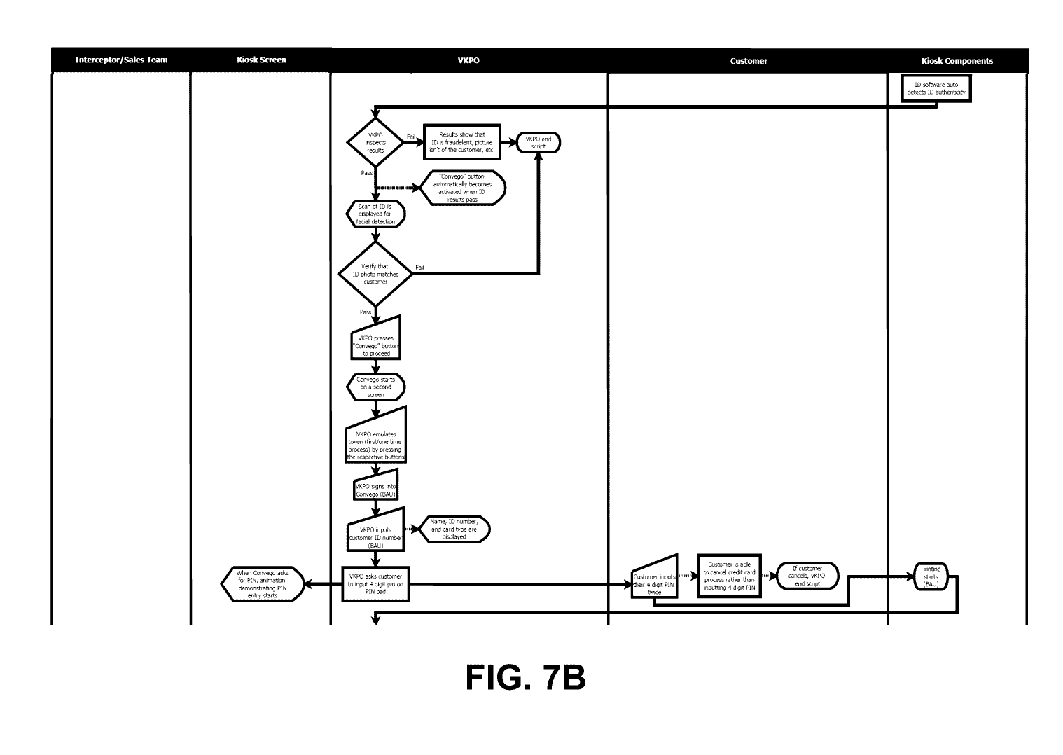

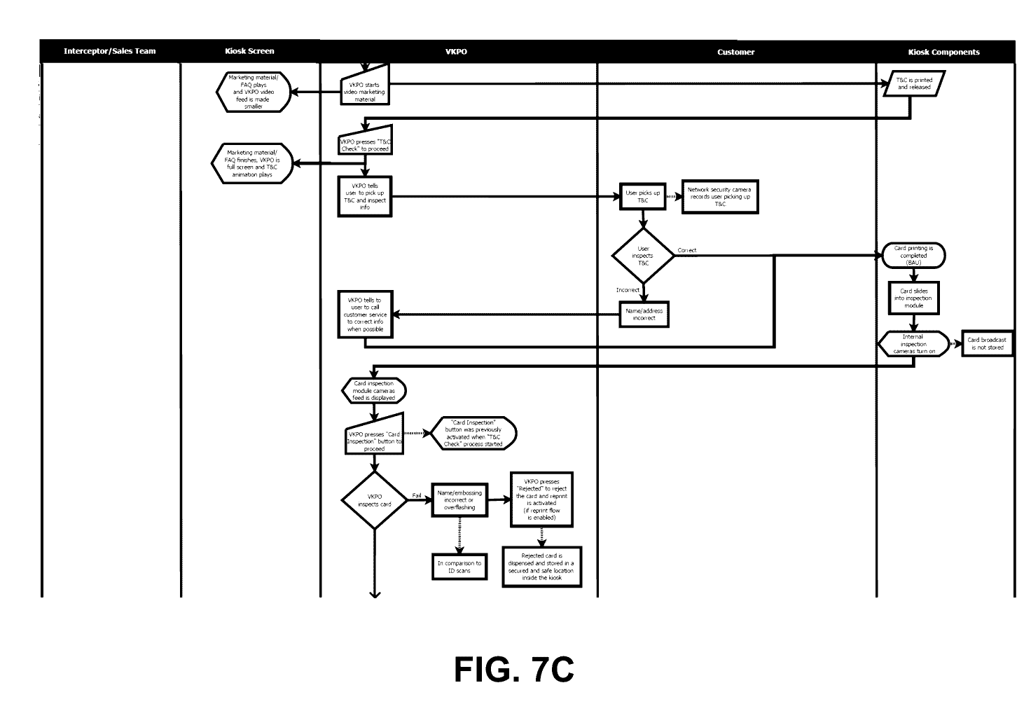

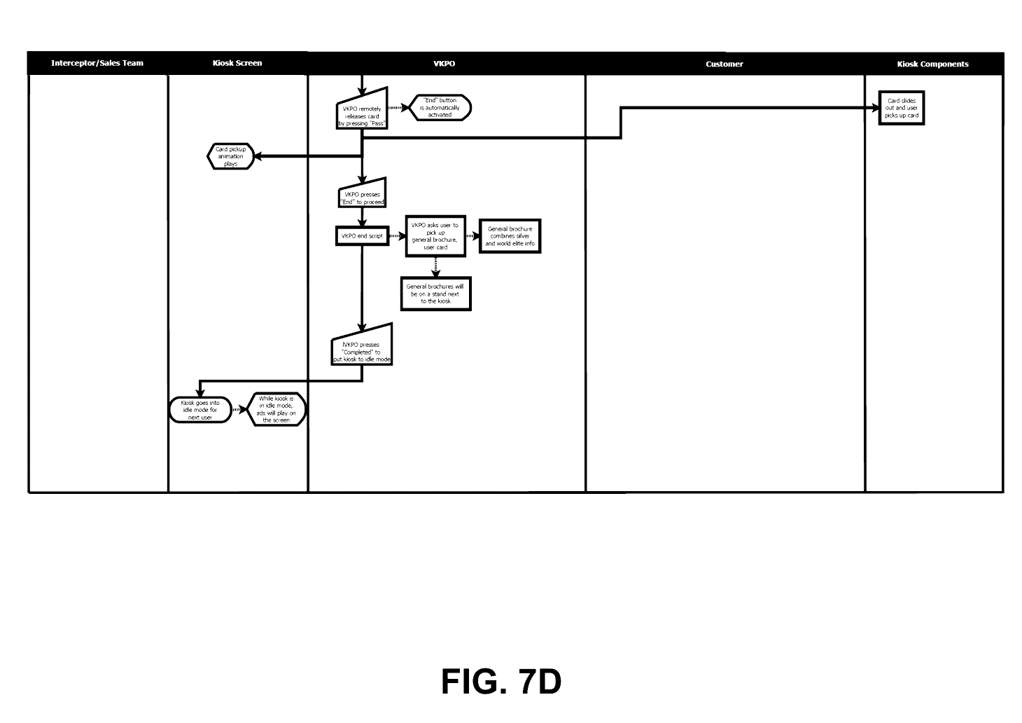

FIGS. 7A-D provide an sample workflow 700 for an embodiment where a remote operator, such as a virtual kiosk print operator (VKPO) assists the customer. The customer is present and operates the kiosk 306 while the VKPO interacts with the customer via the remote operator subsystem 110.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code may be applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. An automated kiosk system for providing a token in a non-secure environment, the token issued by a token issuance authority having customized machine readable data stored thereon, and being provided contemporaneously upon receiving a token provisioning request, the automated kiosk system comprising:
a first computing device having a first processor, first computer readable memory and a first data storage, the first computing device configured to provide:
(i) a user interface to, responsive to the token provisioning request, initiate request signals for the token for a token requester, the user interface configured to receive electronic indicia of credentials provided by the token requester; and
(ii) a validation unit configured to transmit the electronic indicia of credentials to a backend platform and to receive, in response to the transmission of the electronic indicia of credentials, electronic indicia of a provisioning determination;
a token customization unit configured to (i) receive a token blank and to (ii), upon the first computing device receiving a positive electronic indicia of the provisioning determination, customize the token blank by ascribing customized machine readable data based at least on the electronic indicia of credentials provided by the token requester on the token blank; and
a network connection unit configured for establishing one or more communication links between the first computing device and a backend platform;
a secure networking connection including at least the one or more communication links between the first computing device and the backend platform, the secure networking connection adapted to communicate validation and credential information;
the backend platform comprising: a second computing device having a second processor, second computer readable memories and second data storage, the second computing device configured to provide:
(i) a receiver unit configured to receive, through the secure networking connection, the electronic indicia of credentials from the first computing device;
(ii) a token issuance determination engine, configured to maintain, on the second data storage, one or more electronic conditions based at least on requirements provided by the token issuance authority; and
(iii) a verification unit, configured to determine, by applying the one or more electronic conditions, whether a token requester is approved for the requested token.

2. The automated kiosk system of claim 1, wherein the automated kiosk system further includes:
a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, the second set of communication links bypassing the first computing device; and
wherein the token customization unit of the first computing device is further configured to customize the token blank using at least the received personal identification information.

3. The automated kiosk system of claim 1, wherein the automated kiosk system further includes:
a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, bypassing the first computing device; and
wherein the verification unit of the backend platform is further configured to receive personal identification information through the second set of communication links, and the determination by the verification unit is based at least on the received personal identification information.

4. The automated kiosk system of claim 1, further comprising:
an anti-tampering unit configured to detect tampering attempts, including at least one of a tilt sensor, a vibration sensor, a proximity sensor, a location sensor, a temperature sensor, a gyroscope, an accelerometer, a case open sensor, and a power loss sensor, the anti-tampering unit configured for communication with at least one of the first computing device and the second computing device to transmit signals representative of a probability of tampering.

5. The automated kiosk system of claim 1, further comprising:
an anti-spoofing unit configured to detect spoofing attempts, including at least one of a packet analyzer, a firewall, and a source authentication unit, the anti-spoofing unit configured for communication with at least one of the first computing device and the second computing device to transmit signals representative of a probability of tampering.

6. The automated kiosk system of claim 1, further comprising:
an anti-tampering unit configured to detect tampering attempts, including at least one of a tilt sensor, a vibration sensor, a proximity sensor, a location sensor, a temperature sensor, a gyroscope, an accelerometer, a case open sensor, and a power loss sensor, the anti-tampering unit configured for communication with at least one of the first computing device and the second computing device to transmit signals representative of a probability of tampering; and
an anti-spoofing unit configured to detect spoofing attempts, including at least one of a packet analyzer, a firewall, and a source authentication unit, the anti-spoofing unit configured for communication with at least one of the first computing device and the second computing device to transmit signals representative of a probability of tampering;
wherein the token issuance determination engine maintaining the one or more electronic conditions is further configured to, based at least on a combination of the signals representative of a probability of tampering and the signals representative of a probability of tampering, cause the token customization unit to electronically customize the token blank to indicate that the token is potentially compromised.

7. The automated kiosk system of claim 6, wherein the token blank is customized by the token customization unit to electronically indicate one or more further acceptance conditions, including at least one of a duration of enhanced scrutiny and a duration of reduced capabilities.

8. The automated kiosk system of claim 6, wherein the token blank is customized by the token customization unit to physically indicate using indentions on the token blank one or more further acceptance conditions, including at least one of a duration of enhanced scrutiny and a duration of reduced capabilities.

9. The automated kiosk system of claim 1, wherein the automated kiosk system is operated by a remote operator connected through the secure networking connection, the remote operator interacting with the token requester through a video link established through the user interface, wherein the user interface maintains a video record of interactions between the remote operator and the token requester; and
wherein the video record of interactions is contemporaneously processed by the backend platform to automatically detect one or more abnormalities in the video record relative to a population set of video records of other interactions; and
wherein the one or more electronic conditions applied by the verification unit includes at least one condition adapted to reject or conditionally approve the token request at least based on the detected one or more abnormalities.

10. The automated kiosk system of claim 9, further comprising
a remote inspection unit configured to provide a token video feed for visual inspection the token for embossing and indenting errors by at least one of the remote operator or one or more internal sensors prior to release of token by the automated kiosk system.

11. A method for contemporaneously providing a token upon receiving a token provisioning request by an automated kiosk system situated in a non-secure environment, the token issued by a token issuance authority having customized machine readable data stored thereon, the method comprising:
initiating, at a user interface of a first computing device, request signals for the token for a token requester including at least electronic indicia of credentials provided by the token requester;
establishing one or more communication links between the first computing device and a backend platform;
transmitting the electronic indicia of credentials to a backend platform across a secure networking connection including at least the one or more communication links between the first computing device and the backend platform, the secure networking connection adapted to communicate validation and credential information;
receiving by the backend platform through the secure networking connection, the electronic indicia of credentials from the first computing device;
maintaining, on the backend platform, one or more electronic conditions based at least on requirements provided by the token issuance authority; and
applying, by the backend platform, the one or more electronic conditions, whether a token requester is approved for the requested token,
receiving, by first computing device, in response to the transmission of the electronic indicia of credentials, electronic indicia of a provisioning determination; and
receiving a token blank from a token feed chamber and upon the first computing device receiving a positive electronic indicia of the provisioning determination, customizing the token blank by ascribing customized machine readable data based at least on the electronic indicia of credentials provided by the token requester on the token blank.

12. The method of claim 11, wherein
the token blank is customized using at least the received personal identification information obtained from a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, the second set of communication links bypassing the first computing device.

13. The method of claim 11, wherein the token blank is customized using at least the received personal identification information obtained from a personal identification entry device configured to be distinct from the first computing device and to communicate personal identification information relating to an account stored at a financial institution to the backend unit through a second set of communication links provided by the secure networking connection that are distinct from the one or more communication links between the computing device and the backend unit, bypassing the first computing device; and
wherein the backend platform is configured to receive personal identification information through the second set of communication links, and the application of the one or more electronic conditions by the verification unit uses at least on the received personal identification information.

14. The method of claim 11, wherein an anti-tampering unit configured to detect tampering attempts is provided for communication with at least one of the first computing device and the second computing device, and the method further comprises transmitting, by the anti-tampering unit, signals representative of a probability of tampering.

15. The method of claim 11, wherein an anti-spoofing unit configured to detect spoofing attempts is provided for communication with at least one of the first computing device and the second computing device, and the method further comprises transmitting, by the anti-spoofing unit, signals representative of a probability of tampering.

16. The method of claim 11, wherein an anti-tampering unit configured to detect tampering attempts is provided for communication with at least one of the first computing device and the second computing device; and
wherein an anti-spoofing unit configured to detect spoofing attempts is provided for communication with at least one of the first computing device and the second computing device,
the method further comprising:
causing the token customization unit to electronically customize the token blank to indicate that the token is potentially compromised upon a determination of a potentially compromised security based at least on signals received from the anti-tampering unit and the anti-spoofing unit.

17. The method of claim 16, wherein the token blank is customized by the token customization unit to electronically indicate one or more further acceptance conditions, including at least one of a duration of enhanced scrutiny and a duration of reduced capabilities.

18. The method of claim 16, wherein the token blank is customized by the token customization unit to physically indicate using indentions on the token blank one or more further acceptance conditions, including at least one of a duration of enhanced scrutiny and a duration of reduced capabilities.

19. The method of claim 11, further comprising:
recording a video record of the customized token during or after customization;
automatically performing a visual inspection of the customized token by comparing one or more attributes of the customized token with a plurality of video records recorded in relation to a plurality of previous customized tokens;
upon detecting one or more abnormalities in the customized token, rejecting the customized token and re-customizing a new token blank obtained from a token feeder.

20. A non-transitory computer readable medium, storing machine-readable instructions, which when executed by a processor, cause the processor to perform steps of:
initiating, at a user interface of a first computing device, request signals for the token for a token requester including at least electronic indicia of credentials provided by the token requester;
establishing one or more communication links between the first computing device and a backend platform;
transmitting the electronic indicia of credentials to a backend platform across a secure networking connection including at least the one or more communication links between the first computing device and the backend platform, the secure networking connection adapted to communicate validation and credential information;
receiving by the backend platform through the secure networking connection, the electronic indicia of credentials from the first computing device;
maintaining, on the backend platform, one or more electronic conditions based at least on requirements provided by the token issuance authority; and
applying, by the backend platform, the one or more electronic conditions, whether a token requester is approved for the requested token;
receiving, by first computing device, in response to the transmission of the electronic indicia of credentials, electronic indicia of a provisioning determination;
receiving a token blank from a token feed chamber; and
upon the first computing device receiving a positive electronic indicia of the provisioning determination, customizing the token blank by ascribing customized machine readable data based at least on the electronic indicia of credentials provided by the token requester on the token blank.
